(19) United States
(12) Patent Application Publication
(10) Pub. No.: US 2006/0046111 A1
(43) Pub. Date: Mar. 2, 2006

(54) Semi-active full cell apparatus

(76) Inventors: Hsi-Ming Shu, Taipei (TW); Tsang-Ming Chang, Taipei (TW); Feng-Yi Deng, Taipei (TW)

Correspondence Address: G. LINK Co.,LTD, 3550 Bell Road, MINOOKA, IL, 60447, US

(21) Appl. No.: 11/209,705

(22) Filed: Aug. 24, 2005

(30) Foreign Application Priority Data
Aug. 31, 2004 (TW) 093213786

(51) Int. Cl. H01M 8/24; H01M 2/02; H01M 2/36

(52) U.S. Cl. 429/18; 429/34; 429/72

(57) ABSTRACT

The present invention is related to a semi-active fuel cell apparatus, mainly comprising plural fuel cell boards, gas cycling supply unit, fuel replenishing unit, fuel cycling unit, first fuel control unit and second fuel control unit. By way of connecting these constituent elements, the anode fuel is capable of being supplied to the fuel cell boards by cycling means; the gas cathode fuel is capable of being supplied to the fuel cell boards. Meanwhile, the gas cycling supply unit is also used for heat dissipation.

### FIELD OF THE INVENTION

The present invention is related to a fuel cell, especially to a fuel cell having fuel cycling mechanism.

### BACKGROUND OF THE INVENTION

FIG. 1 shows a structural figure of layer lamination integrated fuel cell apparatus. In FIG. 1, layer lamination integrated fuel cell apparatus 10 includes fuel flow layer 25, first electricity/signal transport layer 19, anode current collection layer 13, conduction electrolyte layer 11, cathode current collection layer 15, second electricity/signal transport layer 23 and electromechanical control layer 21, wherein anode current collection layer 13, conduction electrolyte layer 11 and cathode current collection layer 15 constitute the core components 20 of fuel cell.

The used fuel cell is roughly divided into two types of the active fuel cell and passive fuel cell. The means of fuel supply for the active fuel cell is to use the active device like the pump to transport the external anode fuel to the internal fuel cell by pumping the anode fuel like the methanol fuel. Meanwhile, the cathode fuel like air or oxygen is transported by the compressor. The disadvantage of the active fuel cell is that the active device has to consume the power of the fuel cell itself and therefore reduces the real output electricity. Otherwise, the active device is only in charge of transporting the fuel, the reaction of the fuel cell itself and the active device will produce the heat which needs another device to dissipate and therefore increases additional device cost and consumes the electricity of the fuel cell itself so as to be the major disadvantage.

The internal fuel supply of the passive fuel cell is using passive means, for instance, the methanol anode fuel of direct methanol fuel cell is supplied by the gravity or capillary principle. Meanwhile, the cathode fuel of the air or oxygen is obtained by directly contacting the external environment. The disadvantage of the passive fuel cell is that the fuel supply of the fuel cell fails to be directly controlled so as to make the fuel cell inefficient and the reaction efficiency easily influenced by the environment.

The inventor investigates the disadvantages and limitation of the above fuel cell and desires to improve and invent a semi-active fuel cell apparatus to overcome the disadvantages and limitation of the used fuel cell.

### SUMMARY OF THE INVENTION

The first object of the present invention is to provide a semi-active fuel cell apparatus to supply the anode fuel to the fuel cell by cycling means.

The second object of the present invention is to provide a semi-active fuel cell to supply the gas cathode fuel to the fuel cell by gas cycling apparatus and also have heat dissipation function by gas cycling apparatus.

To achieve the above objects, the present invention provides a semi-active fuel cell, comprising plural fuel cell boards which include plural membrane electrode assemblies (MEAs), a cycling inlet, a cycling outlet, gas cycling supply unit which is used to supply cathode fuel to the fuel cell boards and also exhausts the heat produced by the electro-chemical reaction in the fuel cell boards to the outside, a fuel replenishing unit which includes a first inlet and a first outlet, fuel cycling unit which includes a third inlet and a fourth inlet, a first fuel control unit which includes a second outlet and a third outlet and plural fuel outlets wherein the fuel outlets are respectively connected to the cycling outlets of the fuel cell boards and wherein the second inlet is connected to the first outlet of the replenishing unit and also wherein the third inlet is connected to the third outlet of the fuel cycling unit, a second fuel control unit which includes a second outlet and plural fuel inlets wherein the fuel inlets are respectively connected to the cycling outlets of the fuel cell board and wherein the second inlet is connected to the fourth outlet of the fuel cycling unit, and the operation in conjunction between the fuel replenishing unit, fuel cycling unit, the first fuel control unit and the second fuel control unit makes an anode fuel possibly cycling in the fuel cell boards.

The present invention design is innovative and useful in the industry for the improvement so as to apply and disclose the invention. In order to make the people familiar with the art understand the objects, characteristics and improvements, the present invention is detailed below by way of the following embodiments and attached figures.

### BRIEF DESCRIPTION OF THE DRAWINGS

These and other modifications and advantages will become even more apparent from the following detained description of a preferred embodiment of the invention and from the drawings in which:

FIG. 1 shows the structural figure of a layer lamination integrated fuel cell apparatus;

FIG. 2 shows the decomposed figure of the present invention semi-active fuel cell;

FIG. 3 shows the structural figure of the present invention using a housing case to accommodate the semi-active fuel cell;

FIG. 4 shows the structural figure of the present invention first fuel control unit; and

FIG. 5 shows the structural figure of the present invention second fuel control unit.

### DETAILED DESCRIPTION OF THE INVENTION

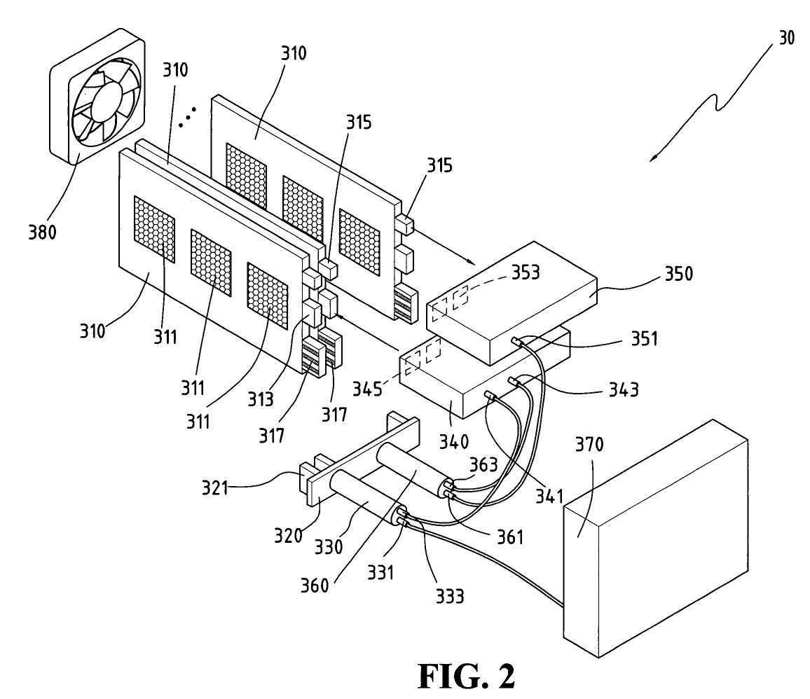

FIG. 2 shows the decomposed figure of the present invention semi-active fuel cell. The present invention semi-active fuel cell apparatus 30 mainly comprises plural fuel cell boards 310, electrically plugging board 320, fuel replenishing unit 330, first fuel control unit 340, second fuel control unit 350, fuel cycling unit 360, fuel storage unit 370 and gas cycling supply unit 380.

Each piece of the present invention fuel cell board 310 has plural membrane electrode assemblies (MEAs) 311, every fuel cell board 310 is placed cycling inlet 313, cycling outlet 315 and golden finger 317 wherein the anode fuel is possible to flow from cycling inlet 313 into the MEAs 311, and flow outward from cycling outlet 315.

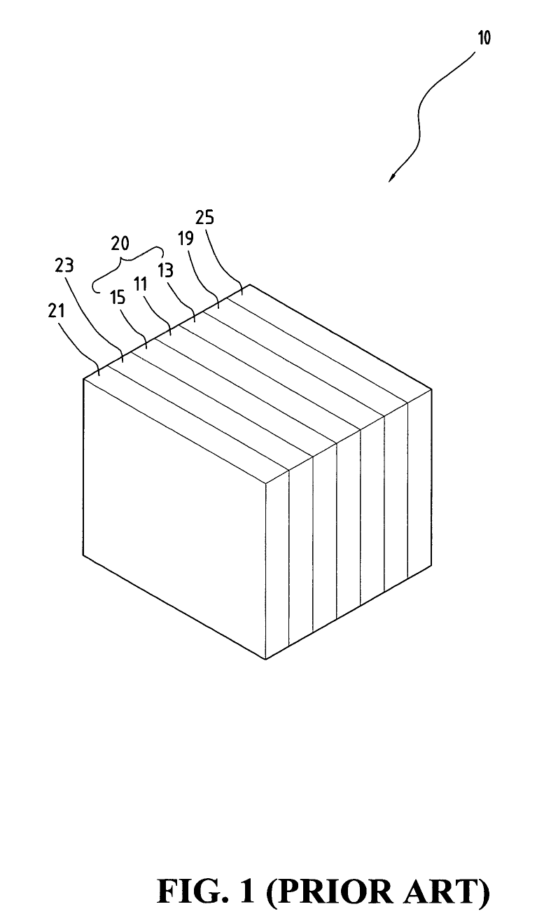

The present invention fuel cell board 310 is possible to be produced by modifying layer lamination integrated fuel cell apparatus 10, referring to FIG. 1. The present invention cycling inlet 313 and cycling outlet 315 are possibly placed on one side of fuel flow layer 25, and the present invention golden finger 317 is possibly placed on one side of electromechanical control layer 21. The embodiment means to produce fuel cell board 310 is possible to use the print circuit board (PCB) process and the material suitable for the PCB process.

The implement means of electrically plugging board 320 is capable of being a Printed Circuit Board (PCB) and soldering plural electrically connecting apparatus 321 on electrically plugging board 320, each electrically connecting apparatus 321 is electrically coupling to each corresponding golden finger 317 of fuel cell board 310. The function of electrically plugging board 320 is to produce a desired output voltage by processing the electricity produced from fuel cell boards 310 in serial/parallel combination. Furthermore, electrically plugging 320 is also electrically connecting to fuel replenishing unit 330 and fuel cycling unit 360 to offer the electricity required for the operation of supply unit 330 and 360.

Fuel replenishing unit 330 is placed first inlet 331 and first outlet 333 to possibly input the anode fuel from first inlet 331. Fuel replenishing unit 330 is capable of being a pump or motor to pressure the anode fuel and output from first outlet 333. First fuel control unit 340 is placed second inlet 341, third inlet 343 and plural fuel outlets 345. Second inlet 341 is connected to first inlet 331 to input compressed anode fuel. Each fuel outlets 345 is respectively connected to cycling inlet 313 of each fuel cell board 310 to input the compressed anode fuel to the inside of fuel cell board 310.

Second fuel control unit 350 is placed a second outlet 351 and plural fuel inlets 353 wherein each fuel inlet 353 is respectively connected to cycling outlet 315 of each fuel cell board 310 to transport and output the anode fuel flowing from fuel cell board 310 into the inside of second fuel control unit 350.

Fuel cycling unit 360 comprises fourth inlet 361 and third outlet 363 wherein fourth inlet 361 is connected to second outlet 351, and third outlet 363 is connected to third inlet 343 to input again the anode fuel located inside second fuel control unit 350 into first fuel control unit 340. Fuel cycling unit 360 is capable of being a pump or motor, and fuel replenishing unit 330 and fuel cycling unit 360 are able to offer the required electricity by way of electrically plugging board 320.

Fuel storage unit 370 is used to store the anode fuel and connect to first inlet 331 of fuel replenishing unit 330, and also pushes and inputs the anode fuel located inside fuel storage unit 370 into fuel cell boards 310 by the pushing force produced by fuel replenishing unit 330.

The new anode fuel is continuously replenished by fuel storage unit 370, meanwhile, the anode fuel flowing from fuel cell boards 310 is able to be re-collected and utilized again through second fuel control unit 350 and therefore the anode fuel flowing through fuel cell boards 310 is recycling. Again, the power produced by fuel replenishing unit 330 and fuel cycling unit 360 makes the cycling effect of the anode fuel more efficient.

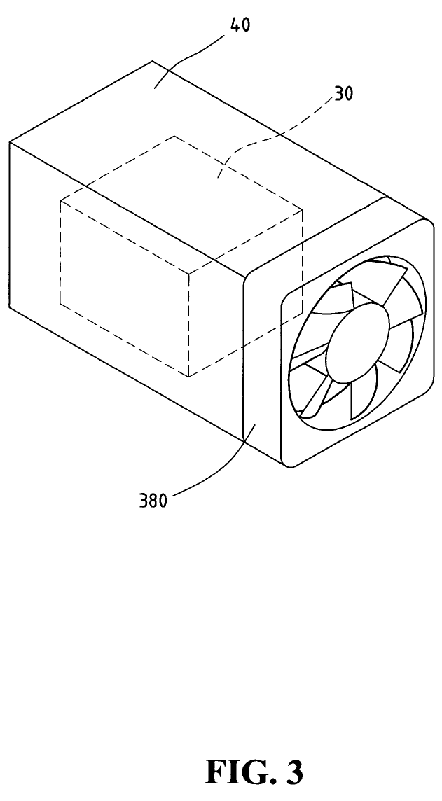

Referring to FIG. 3, the present invention in advance comprises housing case 40 to accommodate semi-active fuel cell apparatus 30. Furthermore, gas cycling supply unit 380 is possibly placed on housing case 40 to inhale the fresh air into housing case 40. Meanwhile, the heat produced by the electro-chemical reaction in fuel cell boards 310 and distributed over the inside of housing case 40 is exhausted outward by gas cycling supply unit 380. The embodiment means of gas cycling supply unit 380 is able to use the fan of which the quantity of placed fan 380 is disposed according to the design of gas flow field to meet the quantity required for fuel cell boards 310 and also achieve excellent heat dissipation.

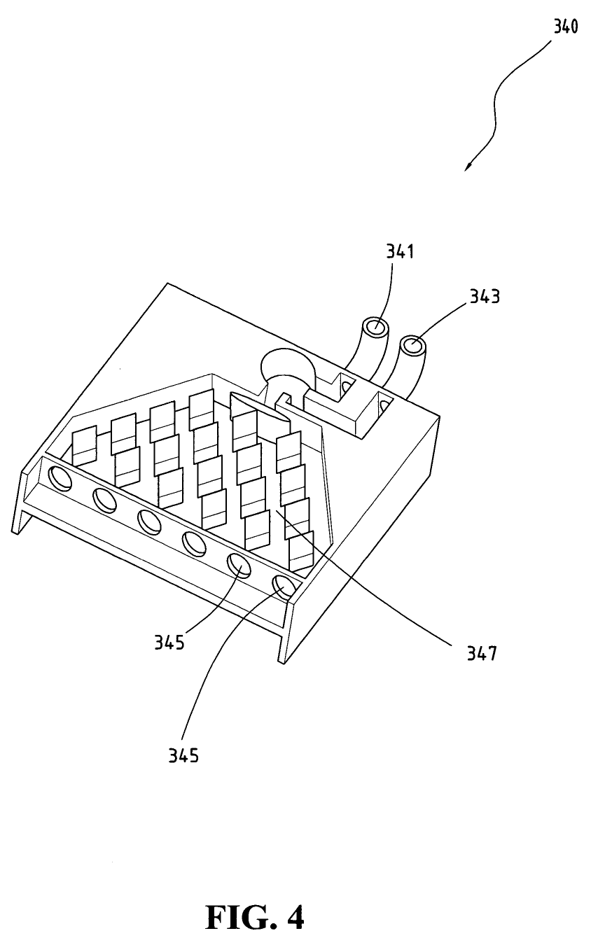

FIG. 4 shows the structural figure of the present invention first fuel control unit. The branch channels 347 placed inside the first fuel control unit 340 are able to uniformly mix the different concentration of solutions injected from the second inlet 341 and third inlet 343 and output into fuel cell board 310 respectively from plural fuel outlets 345.

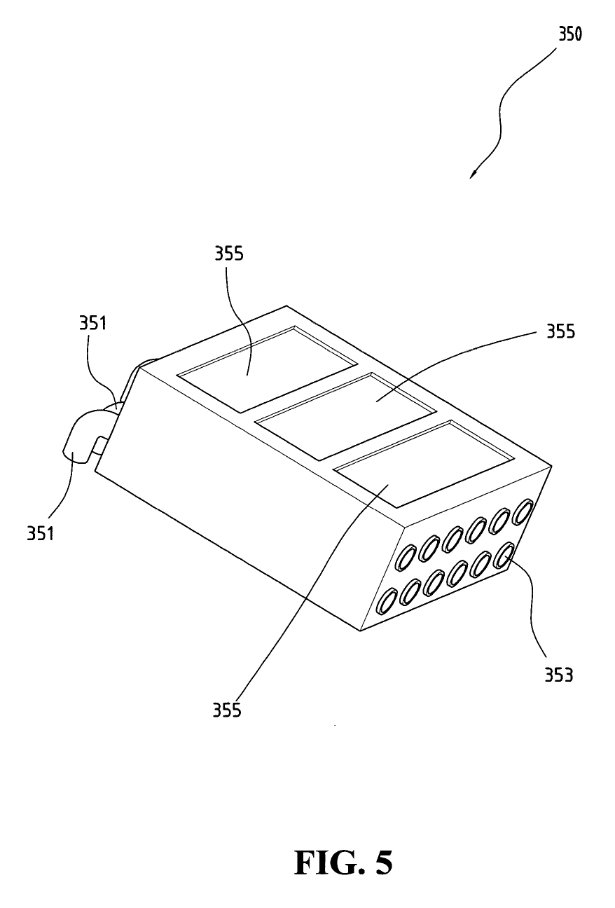

FIG. 5 shows the structural figure of the present invention second fuel control unit. Second fuel control unit 350 is placed the gas ventilation but liquid isolation mechanism 355 to exhaust the carbon-dioxide produced by the anode reaction of fuel cell.

Fuel cell board 310 of the present invention semi-active fuel cell apparatus 30 is able to use methanol fuel cell and hydro-oxygen fuel cell as the embodiment means.

The above described embodiments are examples for convenient interpretations; the rights scope claimed by the present invention is based on the following claims and not limited by the above embodiments.

What is claimed is:

1. A semi-active fuel cell apparatus, comprising:
plural fuel cell boards, comprising plural membrane electrode assemblies (MEAs), a cycling inlet and a cycling outlet;
a gas cycling supply unit, used to supply a cathode fuel to the fuel cell boards and exhaust the heat produced by the electro-chemical reaction in the fuel cell boards to the outside;
a fuel replenishing unit, comprising a first inlet and a first outlet;
a fuel cycling unit, comprising a third inlet and a fourth inlet;
a first fuel control unit, comprising a second outlet and a third outlet and plural fuel outlets, wherein the fuel outlets are respectively connected to the cycling inlets of the fuel cell boards and wherein the second inlet is connected to the first outlet of the fuel replenishing unit and again wherein the third inlet is connected to the third outlet of the fuel cycling unit;
a second fuel control unit, comprising a second outlet and plural fuel inlets wherein the fuel inlets are respectively connected to the cycling outlets of the fuel cell board and wherein the second inlet is connected to the fourth outlet of the fuel cycling unit;
by the operation in conjunction between the fuel replenishing unit, the fuel cycling unit, the first fuel control unit and the second fuel control unit, an anode fuel is possibly cycling in the fuel cell boards.

2. The semi-active fuel cell apparatus of claim 1, further comprising an electrically plugging board which is electrically coupling to the fuel cell boards, wherein the electrically plugging board in advance comprises plural electrically connecting apparatus placed thereon.

3. The semi-active fuel cell apparatus of claim 1, further comprising a fuel storage unit storing the anode fuel which is connected to the first outlet of the fuel replenishing unit.

4. The semi-active fuel cell apparatus of claim 1, wherein the fuel replenishing unit is selected from a pump or a motor.

5. The semi-active fuel cell apparatus of claim 1, wherein the fuel cycling unit is selected from a pump or a motor.

6. The semi-active fuel cell apparatus of claim 1, wherein the gas cycling supply unit is a fan.

7. The semi-active fuel cell apparatus of claim 1, further comprising a housing case which accommodates the fuel cell boards, the gas cycling supply unit, the fuel replenishing unit, the fuel cycling unit, the first fuel control unit and the second fuel control unit.

8. The semi-active fuel cell apparatus of claim 7, wherein the gas cycling supply unit is placed on the housing case.

9. The semi-active fuel cell apparatus of claim 1, wherein each fuel cell board in advance comprises a golden finger.

10. The semi-active fuel cell apparatus of claim 1, wherein the fuel cell board is a fuel cell manufactured by utilizing printed circuit board (PCB) process.

11. The semi-active fuel cell apparatus of claim 1, wherein the fuel cell board is a layer lamination integrated fuel cell.

12. The semi-active fuel cell apparatus of claim 1, wherein the fuel cell board is a methanol fuel cell.

13. The semi-active fuel cell apparatus of claim 1, wherein the fuel cell board is a hydro-oxygen fuel cell.

14. The semi-active fuel cell apparatus of claim 1, wherein the first fuel control unit is in advance placed plural branch channels inside.

15. The semi-active fuel cell apparatus of claim 1, wherein the second fuel control unit is in advance placed a gas ventilation but liquid isolation mechanism.
